(19) United States
(12) Patent Application Publication
(10) Pub. No.: US 2006/0140106 A1
(43) Pub. Date: Jun. 29, 2006

(54) Optical recording material, optical recording medium and method for manufacturing optical recording medium

(75) Inventors: Masahiro Shinkai, Tokyo (JP); Junji Tanabe, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 11/105,448

(22) Filed: Apr. 14, 2005

(30) Foreign Application Priority Data
Apr. 20, 2004 (JP) P2004-124594

(51) Int. Cl. G11B 7/24

(52) U.S. Cl. 369/272.1; 369/275.1

(57) ABSTRACT

An optical recording medium capable of recording information by irradiation of light is provided with a substrate on which there is formed a recording layer which contains an organic dye comprising an organic dye matrix, and at least one C7 or greater branched organic group bonded by a single bond to the organic dye matrix and branching at a prescribed position into a C5 or greater organic group and a functional group other than a hydrogen atom, and/or at least two C5 or greater organic groups. This adequately prevents gas generation due to thermal decomposition of the organic dye, and the accompanying pressure fluctuation, even with the increasing temperature produced by irradiation with a high power laser, so that it becomes possible to form precise recording pits while achieving a high level of sensitivity and high speed responsiveness even under high-temperature conditions.

### BACKGROUND OF THE INVENTION

1. Field of the Invention

The present invention relates to an optical recording material used in an optical recording medium which accomplishes recording of information by irradiation of light, as well as to an optical recording medium and a method for manufacturing the optical recording medium.

2. Related Background Art

Conventional optical recording media record information by irradiation of laser light onto a recording layer to produce deformational changes, magnetic changes or phase changes in the recording layer. Such optical recording media include, for example, write-once optical recording media which employ organic dyes, and are widely used as CD-R (Compact Disk-Recordable ) and DVD-R (Digital Video Disk-Recordable) media.

Demand has risen in recent years for higher recording density using such optical recording media. High density is being achieved by using shorter wavelengths as the recording and reading wavelengths. The current recording/reading wavelength for CD-Rs, for example, is 780 nm, but the next-generation CD-R and DVD-R media use wavelengths as short as 635-680 nm. Optical recording media suitable for such short wavelengths are provided with recording layers comprising organic dyes such as cyanine dyes and metal-azo dyes (see, for example, Japanese Patent Application Laid-Open No. HEI 6-320869, Japanese Patent Application Laid-Open No. HEI 9-58123).

### SUMMARY OF THE INVENTION

With the demand for greater density, techniques for achieving higher data recording speeds on optical recording media are also being investigated. Increased speed car, be achieved by increasing the rotation speed of the optical recording medium and increasing the power of the irradiating laser. In this case, the essential requirements for the optical recording medium are sensitivity, high speed responsiveness, and the ability to form precise recording pits even under the high temperature conditions of irradiation with a high power laser.

With such conventional optical recording media, however, the increased temperature produced by laser irradiation tends to result in a phenomenon in which the shapes of the recording pits formed in the recording layer deviate significantly from the intended pit shapes. In addition, conventional optical recording media are not always satisfactory from the standpoint of sensitivity and high speed responsiveness.

The present invention has been accomplished in light of these circumstances, and its object is to provide an optical recording material which allows formation of precise recording pits under high-temperature conditions and exhibits excellent sensitivity and high speed responsiveness, as well as an optical recording medium and a method for manufacturing the optical recording medium.

As a result of much diligent research directed toward achieving the aforestated object, the present inventors first discovered that the phenomenon of recording pit shape deviation under high temperature conditions is due to thermal decomposition of the organic dye in the recording layer. Specifically, a portion of the organic dye gasifies by thermal decomposition and produces an atmosphere pressure fluctuation, and because the next recording pit is formed before the pressure is adequately relieved, the formed recording pit deviates significantly from the intended pit shape. The major component of the generated gas is not that produced by decomposition of the organic dye matrix, but rather is produced by dissociation of low molecular weight organic groups bonded to the organic dye matrix or portions of those organic groups.

The generation of gas can be limited by using an organic dye lacking such organic groups. However, the recording layer containing the organic dye is usually formed by a coating method, and since organic dyes without organic groups are inadequately soluble they are not suitable for practical use.

As a result of further research based on this finding, the present inventors also discovered that the problem described above can be overcome by adding to the recording layer an organic dye having a specific structure, and the present invention was thereupon completed.

Specifically, the optical recording material of the invention is an optical recording material used for an optical recording medium capable of recording information by irradiation of light, which comprises an organic dye having an organic dye matrix, and at least one C7 or greater branched organic group bonded by a single bond to the organic dye matrix and branching at a prescribed position into a C5 or greater organic group and a functional group other than a hydrogen atom, and/or at least two C5 or greater organic groups other than the branched organic group.

The organic recording medium of the invention is an optical recording medium capable of recording information by irradiation of light, provided with a recording layer comprising an organic dye having an organic dye matrix, and at least one C7 or greater branched organic group bonded by a single bond to the organic dye matrix and branching at a prescribed position into a C5 or greater organic group and a functional group other than a hydrogen atom, and/or at least two C5 or greater organic groups other than the branched organic group(s).

According to the invention, including the aforementioned specific organic dye in the recording layer adequately prevents both generation of gas by thermal decomposition under high-temperature conditions and the accompanying pressure fluctuation. Since the organic dye of the invention has a C5 or greater organic group, the solubility in the coating solution used for formation of the recording layer will not be impaired. An optical recording medium according to the invention allows formation of precise recording pits while achieving a high level of sensitivity and high speed responsiveness, even when recording of information is accomplished by irradiation with a high power laser.

The term “organic dye matrix” used for the description of the invention means a structural unit exhibiting the properties of a dye, and as preferred examples there may be mentioned residues represented by the following general formulas (1) to (4) minus their respective groups R¹—R¹⁰.

According to the invention, the organic dye is preferably one wherein the C5 or greater organic group dissociates at a lower temperature than the kick-off temperature of the organic dye matrix. By using an organic dye with this type of structure it is possible to effectively inhibit pressure fluctuation which occurs with generation of gas.

The organic dye of the invention preferably has a structure represented by any of the following general formulas (1) to (4). 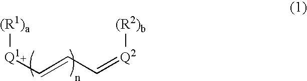
wherein Q¹ and Q² may be the same or different and each represents a nitrogen-containing heterocycle optionally including a fused ring, n represents an integer of 0-3, R¹ and R² may be the same or different and each represents a C7 or greater branched organic group branching at a prescribed position into a C5 or greater organic group and a functional group other than a hydrogen atom, or a C5 or greater organic group other than the branched organic group, and “a” and “b” may be the same or different and each represents an integer, provided that when the “a” number of R¹ groups and “b” number of R² groups include the aforementioned branched organic group, the sum of “a” and “b” is 1 or greater, and when the “a” number of R¹ groups and “b” number of R² groups do not include the aforementioned branched organic group, the sum of “a” and “b” is 2 or greater. 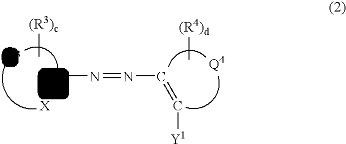
wherein Q³ and Q⁴ may be the same or different and each represents a group of atoms forming an aromatic ring, X represents a carbon atom, nitrogen atom, oxygen atom or sulfur atom, Y¹ represents hydroxyl, carboxyl or sulfone, R³ and R⁴ may be the same or different and each represents a C7 or greater branched organic group branching at a prescribed position into a C5 or greater organic group and a functional group other than a hydrogen atom, or a C5 or greater organic group other than the branched organic group, and “c” and “d” may be the same or different and each represents an integer, provided that when the “c” number of R³ groups and “d” number of R⁴ groups include the aforementioned branched organic group, the sum of “c” and “d” is 1 or greater, and when the “c” number of R³ groups and “d” number of R⁴ groups do not include the aforementioned branched organic group, the sum of “c” and “d” is 2 or greater. 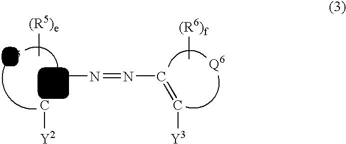
wherein Q⁵ and Q⁶ may be the same or different and each represents a group of atoms forming an aromatic ring, Y² and Y³ may be the same or different and each represents hydroxyl, carboxyl or sulfone, R⁵ and R⁶ may be the same or different and each represents a C7 or greater branched organic group branching at a prescribed position into a C5 or greater organic group and a functional group other than a hydrogen atom, or a C5 or greater organic group other than the branched organic group, and “e” and “f” may be the same or different and each represents an integer, provided that when the “e” number of R⁵ groups and “f” number of R⁶ groups include the aforementioned branched organic group, the sum of “e” and “f” is 1 or greater, and when the “e” number of R⁵ groups and “f” number of R⁶ groups do not include the aforementioned branched organic group, the sum of “e” and “f” is 2 or greater. 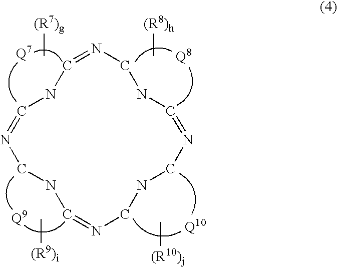
wherein Q⁷, Q⁸, Q⁹ and Q¹⁰ may be the same or different and each represents a group of atoms forming an aromatic ring, R⁷, R⁸, R⁹ and R¹⁰ may be the same or different and each represents a C7 or greater branched organic group branching at a prescribed position into a C5 or greater organic group and a functional group other than a hydrogen atom, or a C5 or greater organic group other than the branched organic group, and “g”, “h”, “i” and “j” may be the same or different and each represents an integer, provided that when the “g” number of R⁷ groups, “h” number of R⁸ groups, “i” number of R⁹ groups and “j” number of R¹⁰ groups include the aforementioned branched organic group, the sum of “g”, “h”, “i” and “j” is 1 or greater, and when the “g” number of R⁷ groups, “h” number of R⁸ groups, “i” number of R⁹ groups and “j” number of R¹⁰ groups do not include the aforementioned branched organic group, the sum of “g”, “h”, “i” and “j” is 2 or greater.

The C5 or greater organic group of the organic dye of the invention is preferably one selected from among aryl, arylalkyl, alkylaryl, cycloalkyl, alkylcycloalkyl, cycloalkylalkyl and adamantane residues having one hydrogen atom removed. By using an organic dye have such an organic group, it is possible to effectively inhibit pressure fluctuation which occurs with generation of gas. All of the aforementioned organic groups have cyclic structures, and using organic dyes having such organic groups will adequately inhibit broadening of the melting point of the organic dye that occurs with increasing carbon number, thereby further increasing the sensitivity and high-speed responsiveness.

According to the invention, the organic dye preferably has a structure represented by general formula (1) above, and the optical recording material or the recording layer of the optical recording medium further also preferably comprises a chelate compound of an azo compound and a metal. By using an organic dye represented by general formula (1) in combination with a chelate compound, it is possible to effectively prevent reading defects caused by oxidative deterioration of the organic dye.

The manufacturing method for an optical recording medium according to the invention comprises a first step of preparing an organic dye comprising an organic dye matrix, and at least one C7 or greater branched organic group bonded by a single bond to the organic dye matrix and branching at a prescribed position into a C5 or greater organic group and a functional group other than a hydrogen atom, and/or at least two C5 or greater organic groups other than the branched organic group, a second step of preparing a coating solution containing the organic dye, and a third step of applying the coating solution onto an article to be processed to form a recording layer.

According to the manufacturing method described above, it is possible to easily and reliably obtain an optical recording medium of the invention which allows formation of precise recording pits under high-temperature conditions, and which exhibits excellent sensitivity and high-speed responsiveness.

It is preferred to select an organic dye whose C5 or greater organic dye dissociates at a lower temperature than the kick-off temperature of the organic dye matrix in the second step of the manufacturing method of the invention. This will more reliably prevent pressure fluctuation due to generation of gas in the obtained optical recording medium.

### BRIEF DESCRIPTION OF THE DRAWINGS

FIG. 1 is a graph as an example of a DSC chart for an organic dye according to the invention.

FIG. 2 is a partial cross-sectional view showing a preferred embodiment of an optical recording disk as an optical recording medium according to the invention.

FIG. 3 is a partial cross-sectional view showing another preferred embodiment of an optical recording disk as an optical recording medium according to the invention.

### DETAILED DESCRIPTION OF THE PREFERRED EMBODIMENTS

Preferred embodiments of the invention will now be explained with reference to the accompanying drawings where appropriate.

(Organic Dye)

The organic dye of the invention comprises an organic dye matrix, and at least one C7 or greater branched organic group bonded by a single bond to the organic dye matrix and branching at a prescribed position into a C5 or greater organic group and a functional group other than a hydrogen atom, and/or at least two C5 or greater organic groups other than the branched organic group(s).

The organic dye matrix preferably has a cyanine structure, a phthalocyanine structure, an azo structure and a pyromethene structure. A cyanine structure is a structure wherein two heterocycles are bonded via a methine chain. An azo structure is a structure wherein two heterocycles are bonded via an azo group. As heterocycles in these structures there may be mentioned indolenine ring, 4,5-benzoindolenine ring, selenazoline ring, pyridine ring, thiazoline ring, benzothiazoline ring, oxazoline ring, benzooxazoline ring, quinoline ring, imidazoline ring, pyrazine ring, pyrrole ring and the like.

The one or more C7 or greater branched organic groups branching at a prescribed position into a C5 or greater organic group and a functional group other than a hydrogen atom and/or two or more C5 or greater organic groups other than the branched organic group(s), are bonded to the organic dye matrix by a single bond. The C7 or greater branched organic group and the C5 or greater organic group may also contain nitrogen atoms, oxygen atoms, sulfur atoms, halogen atoms and the like in addition to the carbon and nitrogen atoms. As C5 or greater organic groups there may be mentioned alkyl, alkoxy, acyl, alkylamino, aryl, arylalkyl, alkylaryl, cycloalkyl, alkylcycloalkyl and adamantane residues having one hydrogen atom removed, as well as these organic groups substituted with halogens. Among these, aryl groups such as phenyl and naphthyl, arylalkyl, alkylaryl, cycloalkyl, alkylcycloalkyl and adamantane residues having one hydrogen atom removed are preferred. As branched organic groups there may be mentioned organic groups branched at a prescribed position into a C5 or greater organic group and a functional group other than a hydrogen atom. The functional group other than hydrogen may be a C5 or greater organic group, or it may be a lower-than C5 organic group such as methyl or ethyl, or even a functional group with no carbon atoms, such as amino. The branching position of the branched organic group may be at a secondary or tertiary carbon atom, or at a tertiary nitrogen atom.

When one or more C7 or greater branched organic groups are bonded to the organic dye matrix, the total number of carbon atoms of the branched organic group is preferably 13 or greater, and more preferably 13-21. The number of carbon atoms of the C5 or greater organic group of the branched organic group is preferably 6 or greater, and more preferably 6-20. In this case, a C5 or greater organic group other than the C7 or greater branched organic group may also be bonded to the organic dye matrix.

When two or more C5 or greater organic groups are bonded to the organic dye matrix, the number of carbon atoms of each organic group is preferably 6 or greater, and more preferably 6-20. In this case, a C7 or greater branched organic group is also preferably bonded to the organic dye matrix.

The bond between the C5 or greater organic group and the organic dye matrix or the main chain of the C7 or greater organic group may be a carbon-carbon bond, a carbon-nitrogen bond or a carbon-oxygen bond, and preferably the C5 or greater organic group dissociates at a temperature lower than the kick-off temperature of the organic dye matrix. By using an organic dye having such a structure, it is possible to effectively inhibit pressure fluctuation which occurs with generation of gas.

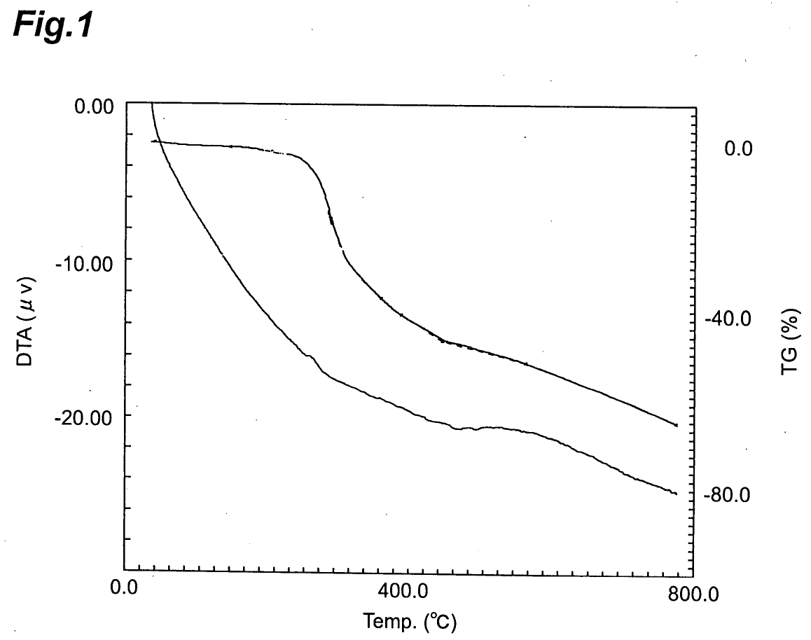

The thermal decomposition property of the organic dye may be evaluated by thermogravimetry (TG) or differential thermal analysis (DTA). FIG. 1 is a graph showing an example of a TG curve and DTA curve for an organic dye. In FIG. 1, curve A is the TG curve and curve B is the DTA curve, for the organic dye represented by formula (47) shown below. As shown in FIG. 1, an initial weight reduction is observed in the region of 210-270° C. of the TG curve. The decomposition products generated in this temperature range can be collected and analyzed to confirm that they correspond to C5 or greater organic groups.

As a preferred example of an organic dye according to the invention there may be mentioned the cyanine compound having the structure represented by general formula (1) below.

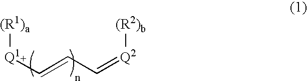

In general formula (1), Q¹ and Q² may be the same or different and each represents a nitrogen-containing heterocycle optionally including a fused ring. The nitrogen-containing heterocycle may also contain an oxygen or sulfur atom in addition to nitrogen. As nitrogen-containing heterocycles there may be mentioned indolenine ring, 4,5-benzoindolenine ring, selenazoline ring, pyridine ring, thiazoline ring, benzothiazoline ring, oxazoline ring, benzooxazoline ring, quinoline ring, imidazoline ring, pyrazine ring, pyrrole ring and the like, among which indolenine ring, 4,5-benzoindolenine ring, thiazole ring, oxazoline ring and quinoline ring are preferred. Substituents other than R¹ and R² may also be bonded in addition to Q¹ and Q². For example, a halogen or nitrogen group may be bonded to a carbon atom of the nitrogen-containing heterocycle. Alternatively, an alkyl group or the like may be bonded to a nitrogen atom of the nitrogen-containing heterocycle. A C5 or greater organic group may also be bonded to the same atom as the atoms to which R¹ and R² are bonded.

Also, n in general formula (1) represents an integer of 0-3. The structure of the methine chain may be selected as appropriate for the wavelength of the recording and reading light. For example; pentamethine (n=3) is preferred when the recording and reading light is in a wavelength range of 770-830 nm, and trimethine (n=2) is preferred when the recording and reading light is in a wavelength range of 630-685 nm.

R¹ and R² in general formula (1) may be the same or different and each represents a branched organic group branching at a prescribed position into a C5 or greater organic group and a functional group other than a hydrogen atom, or a C5 or greater organic group other than the branched organic group.

Also, “a” and “b” may be the same or different and each represents an integer. When the “a” number of R¹ groups and “b” number of R² groups include the aforementioned specific branched organic group, the sum of “a” and “b” is 1 or greater. When the “a” number of R¹ groups and “b” number of R² groups do not include the branched organic group, i.e. when all of the “a” number of R¹ groups and “b” number of R² groups are C5 or greater organic groups other than the aforementioned specific branched organic group, the sum of “a” and “b” is 2 or greater.

The organic dye represented by general formula (1) may be used as a salt with a prescribed counter ion (preferably PF₆⁻, BF₄⁻, ClO₄⁻ or the like). Alternatively, it may be used as a salt-forming dye between the organic dye represented by general formula (1) and a metal azo dye (chelate compound of an azo compound and a metal).

As preferred examples of organic dyes according to the invention there may be mentioned azo compounds represented by the following general formulas (2) and (3).

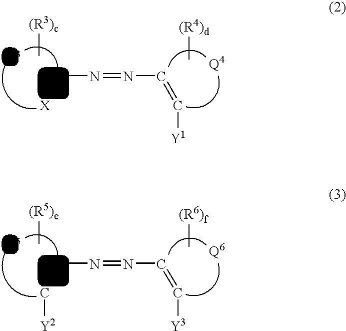

Q³ and Q⁴ in general formula (2) and Q⁵ and Q⁶ in general formula (3) each represent a group of atoms forming an aromatic ring. As aromatic rings there may be mentioned benzene ring, naphthalene ring and the like. Substituents other than R³—R⁶ may also be bonded respectively to the aromatic rings formed including Q³—Q⁶. For example, a halogen or nitro group may be bonded to a carbon atom of the aromatic ring. Also, C5 or greater organic groups may be bonded to the same atoms as the atoms to which R³—R⁶ are bonded.

X in general formula (2) represents a carbon atom, nitrogen atom, oxygen atom or sulfur atom. Y¹ in general formula (2) and Y² and Y³ in general formula (3) each represent a hydroxyl, carboxyl or sulfone group (—SO₂—R; wherein R is a substituted or unsubstituted alkyl group or a substituted or unsubstituted aryl group).

R³ and R⁴ in general formula (2) and R⁵ and R⁶ in general formula (3) each represent a C7 or greater branched organic group branching at a prescribed position into a C5 or greater organic group and a functional group other than a hydrogen atom, or a C5 or greater organic group other than the branched organic group. Also, “c” and “d” in general formula (2) and “e” and “f” in general formula (3) each represent an integer. When the “c” number of R³ groups and “d” number of R⁴ groups include a C7 or greater branched organic group, the sum of “c” and “d” is 1 or greater. When the “c” number of R³ groups and “d” number of R⁴ groups do not include a C7 or greater branched organic group, the sum of “c” and “d” is 2 or greater. Similarly, when the “e” number of R⁵ groups and “f” number of R⁶ groups include the aforementioned specific branched organic group, the sum of “e” and “f” is 1 or greater. When the “e” number of R⁵ groups and “f” number of R⁶ groups do not include the aforementioned specific branched organic group, the sum of “e” and “f” is 2 or greater.

As preferred examples of organic dyes according to the invention there may be mentioned phthalocyanine compounds represented by the following general formula (4).

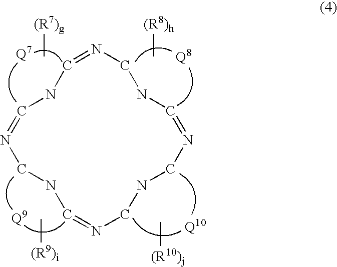

In general formula (4), Q⁷, Q⁸, Q⁹ and Q¹⁰ each represent a group of atoms forming an aromatic ring. As aromatic rings formed including Q⁷-Q¹⁰ there may be mentioned the aromatic rings mentioned for Q¹-Q⁴.

R⁷, R⁸, R⁹ and R¹⁰ each represent a C7 or greater branched organic group, or a functional group other than a hydrogen atom, and “g”, “h”, “i” and “j” each represent an integer. When the “g” number of R⁷ groups, “h” number of R⁸ groups, “i” number of R⁹ groups and “j” number of R¹⁰ groups include the aforementioned specific branched organic group, the sum of “g”, “h”, “i” and “j” is 1 or greater, and when the “g” number of R⁷ groups, “h” number of R⁸ groups, “i” number of R⁹ groups and “j” number of R¹⁰ groups do not include the aforementioned specific branched organic group, the sum of “g”, “h”, “i” and “j” is 2 or greater.

According to the invention, a single organic dye represented by any of general formulas (1) to (4) above may be used, or a combination of two or more thereof may be used. Among these organic dyes there are preferred organic dyes represented by general formula (1), among which cyanine compounds represented by the following formula (5) are particularly preferred.

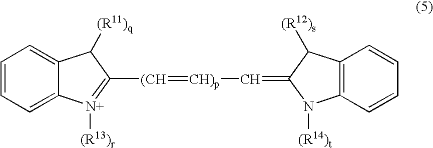

In general formula (5), “p” represents an integer of 1 or greater. Also, R¹¹ and R¹² have the same respective definitions as R¹ and R² in general formula (1) and each represents a C7 or greater branched organic group branching at a prescribed position into a C5 or greater organic group and a functional group other than a hydrogen atom, or a C5 or greater organic group other than the branched organic group, R¹³ and R¹⁴ each represent a branched organic group branching at a prescribed position into a C1-4 organic group and a functional group other than a hydrogen atom, or a C1-4 organic group other than the branched organic group, and “q”, “r”, “s” and “t” each represent an integer. When the “q” number of R¹¹ groups, “r” number of R¹² groups, “s” number of R¹³ groups and “t” number of R¹⁴ groups each include the aforementioned specific branched organic group, the sum of “q”, “r”, “s” and “t” is 1 or greater, and when the “q” number of R¹¹ groups, “r” number of R¹² groups, “s” number of R¹³ groups and “t” number of R¹⁴ groups do not include the aforementioned specific branched organic group, the sum of “q”, “r”, “s” and “t” is 2 or greater.

In the case of a cyanine compound represented by general formula (5), a substituent other than R¹—R⁴ may be bonded to the organic dye matrix so long as it is still possible to inhibit generation of gas by thermal decomposition. For example, when q or s is 0 or 1, an organic group with less than 5 carbon atoms may be bonded to the carbon atom to which (R¹)_{q}— or (R²)ₐ— is bonded. Also, an electron donor group or electron acceptor group may be bonded at a prescribed position of the benzene ring of an indolenine ring. A plurality of substituents bonded to the benzene ring may also bond together to form a ring.

When a cyanine compound represented by general formula (1) is used, it is preferably used in combination with a chelate compound of an azo compound and a metal.

As azo compounds forming the chelate compound there are preferred compounds represented by the following general formulas (6) to (8), and from the standpoint of achieving high levels of both light emitting properties and solubility, compounds represented by general formulas (7) and (8) are particularly preferred.

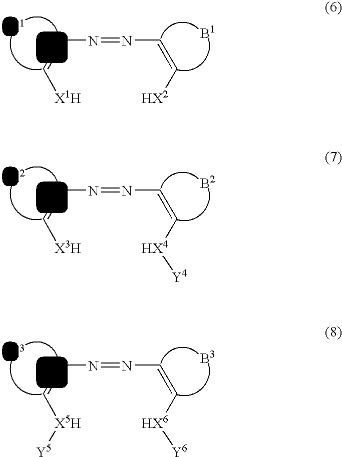

In general formulas (6) to (8) which represent azo compounds, A¹, A², A³, B¹, B² and B³ may be the same or different and each represents a group of atoms forming an aromatic ring. As such aromatic rings there may be specifically mentioned benzene ring and naphthalene ring. The aromatic ring may also have other substituents in addition to —X¹H, —X²H, —X³H, —X⁴H—Y⁴, —X⁵H—Y⁵ or —X⁶H—Y⁶. As suitable substituents there may be mentioned alkyl, aryl, aralkyl, acyl, alkoxy, alkenyl, halogens, hydroxyl, carboxyl, carboxylic acid ester groups, sulfone, sulfonic acid ester groups, sulfamoyl, sulfonamide, carbamoyl, amino, amido, alkylthio, alkylazomethine and nitro. When two or more substituents are bonded to adjacent carbon atoms on the heterocycle, the substituents may be linked to form a ring.

As alkyl group substituents on the aromatic ring there are preferred those with a total of 1-12 carbon atoms. The alkyl groups may be branched or cyclic, or in combinations of two or more. Substituents such as halogens or alkoxy may also be bonded to the alkyl groups.

As aryl groups there may be mentioned phenyl and tolyl. The total number of aryl group carbon atoms is preferably 6-10. The aryl groups may be substituted or unsubstituted.

As acyl groups there may be mentioned acetyl, propionyl and butyryl. The total number of acyl group carbon atoms is preferably 2-5.

As aralkyl groups there may be mentioned benzyl, hydroxybenzyl and methylbenzyl. The total number of aralkyl group carbon atoms is preferably 7-10.

As alkoxy groups there are preferred those with a total of 1-4 carbon atoms, and there may be mentioned methoxy, ethoxy, propoxy and pentafluoropropoxy.

Alkenyl groups may be straight-chain or branched, and specifically there may be mentioned vinyl, allyl, propenyl, butenyl and pentenyl. The total number of carbon atoms is preferably 2-10.

As halogen atoms there may be mentioned fluorine, chlorine and bromine.

Carboxylic acid ester groups preferably have a total of 2-10 carbon atoms, and there may be mentioned methoxycarbonyl, ethoxycarbonyl, propoxycarbonyl and acetoxycarbonyl.

Sulfone groups preferably have a total of 1-10 carbon atoms, and there may be mentioned methylsulfonyl, benzenesulfonyl, ethylsulfonyl and n-propylsulfonyl.

Sulfonic acid ester groups preferably have a total of 1-10 carbon atoms, and there may be mentioned methoxysulfonyl, ethoxysulfonyl, propoxysulfonyl and butoxysulfonyl.

Sulfamoyl groups may be substituted and preferably have a total of 0-10 carbon atoms, and there may be mentioned sulfamoyl, methylsulfamoyl, ethylsulfamoyl, n-propylsulfamoyl and iso-propylsulfamoyl.

Sulfonamide groups preferably have a total of 1-10 carbon atoms, and there may be mentioned methylsulfonamide, ethylsulfonamide and n-propylsulfonamide.

Carbamoyl groups may be substituted and preferably have a total of 1-10 carbon atoms, and there may be mentioned carbamoyl, methylcarbamoyl, ethylcarbamoyl, n-propylcarbamoyl and iso-propylcarbamoyl.

Amino groups are preferably substituted, and dialkylamino groups are particularly preferred as substituted amino groups. The total number of carbon atoms of the alkyl portions of a dialkylamino group is preferably 1-12, and it may be straight-chain or branched.

Amide groups preferably have a total of 2-10 carbon atoms, and there may be mentioned acetoamide, propionylamide, butyrylamide and benzamide.

Alkylthio groups preferably have a total of 1-4 carbon atoms, and there may be mentioned methylthio, ethylthio, n-propylthio and iso-propylthio.

Alkylazomethine groups preferably have a total of 2-5 carbon atoms, and there may be mentioned methylazomethine, ethylazomethine and n-propylazomethine.

X¹, X² and X³ represent residues obtained by removing one active hydrogen atom from functional groups having one or more active hydrogen atoms. As functional groups having one or more active hydrogen atoms there are preferred hydroxyl (—OH), thiol (—SH), amino (—NH₂), carboxyl (—COOH), amide (—CONH₂), sulfonamide (—SO₂NH₂) and sulfo (—SO₃H), with hydroxyl being particularly preferred. Thus, X² is preferably —O—, —S—, —NH—, —COO—, —CONH—, —SO₂NH— or —SO₃—, with —O— being particularly preferred.

X⁴, X⁵ and X⁶ represent residues obtained by removing two active hydrogen atoms from functional groups having two or more active hydrogen atoms. As functional groups having two or more active hydrogen atoms there are preferred amino (—NH₂), amide (—CONH₂) and sulfonamide (—SO₂NH₂), with amino being particularly preferred. Thus, X¹ is preferably —NH—, —CONH— or —SO₂NH—, with —NH— being particularly preferred. The two X¹ groups and two Y¹ groups in formula (2) may be the same or different.

Y⁴, Y⁵ and Y⁶ each represents substituents bonded to X⁴, X⁵ and X⁶. As specific examples of Y⁴—Y⁶ there may be mentioned alkyl, aryl, acyl, alkoxy, halogens, hydroxyl, carboxyl, carboxylic acid ester groups, sulfone, sulfamoyl, sulfonamide, carbamoyl, amide, amino, alkenyl, cyano, nitro, mercapto, thiocyano, alkylthio, alkylazomethine and aralkyl. Among these are preferred alkyl, sulfone (—SO₂—R; wherein R is a substituted or unsubstituted alkyl group or a substituted or unsubstituted aryl group) and acyl (—CO—R; wherein R is a substituted or unsubstituted alkyl group or a substituted or unsubstituted aryl group). When R of a sulfone group or acyl group is alkyl, the alkyl group preferably has 1-6 carbon atoms.

Preferred among the azo compounds represented by general formulas (6) to (8) are compounds represented by general formulas (7) and (8), and compounds having structures represented by the following general formulas (9) and (10) are more preferred.

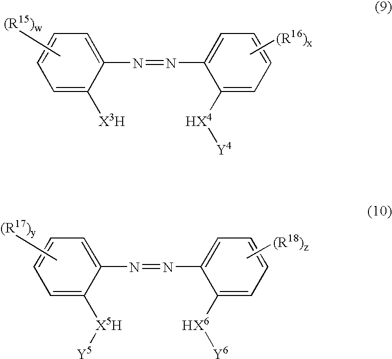

X³, X⁴ and Y⁴ in general formula (9) and X⁵, X⁶, Y⁵ and Y⁶ in formula (10) have the same respective definitions as X³, X⁴ and Y⁴ in general formula (7) and X⁵, X⁶, Y⁵ and Y⁶ in formula (8). Also, R¹⁵ and R¹⁶ in general formula (9) and R¹⁷ and R¹⁸ in general formula (10) may be the same or different, and each represents a monovalent group selected from among alkyl, aryl, acyl, alkoxy, alkenyl, halogens, hydroxyl, carboxyl, carboxylic acid ester groups, sulfone, sulfonic acid ester groups, sulfamoyl, sulfonamide, carbamoyl, amide, amino and nitro, while “w”, “x”, “y” and “z” may be the same or different and each represents an integer of 0-4. When two or more R¹⁵, R¹⁶, R¹⁷ and R¹⁸ are bonded to adjacent carbon atoms on the benzene ring, they may be linked together to form a ring. Also, X⁵ and X⁶ or Y⁵ and Y⁶ in formula (10) may be the same or different.

As more specific preferred examples of azo compounds according to the invention there may be mentioned the compounds represented by the following formulas (11) to (43).

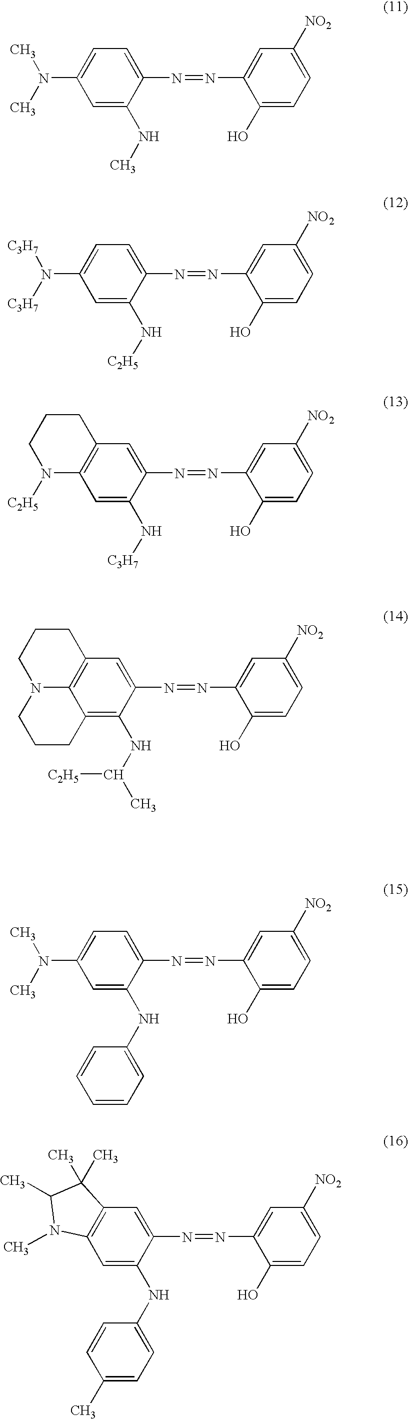

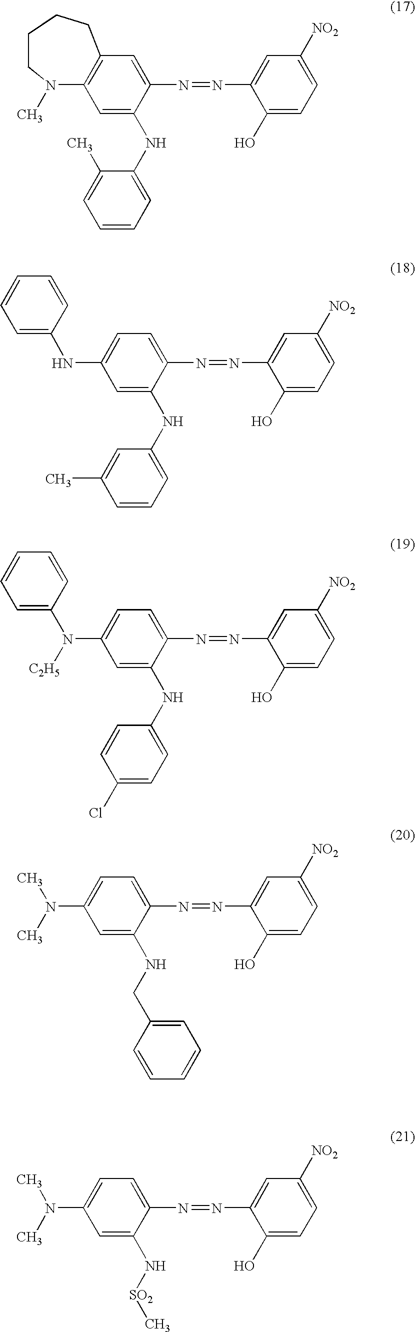

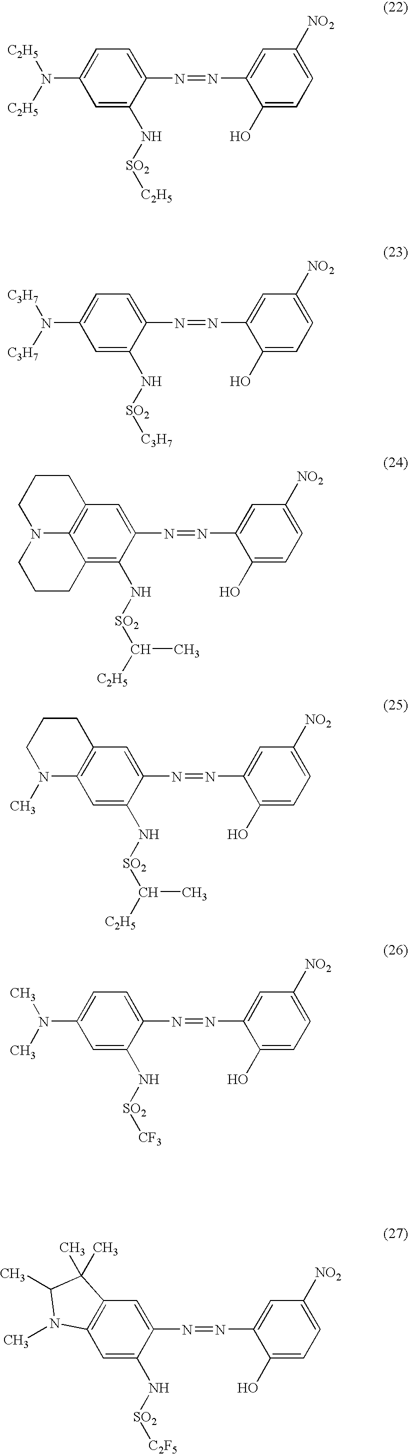

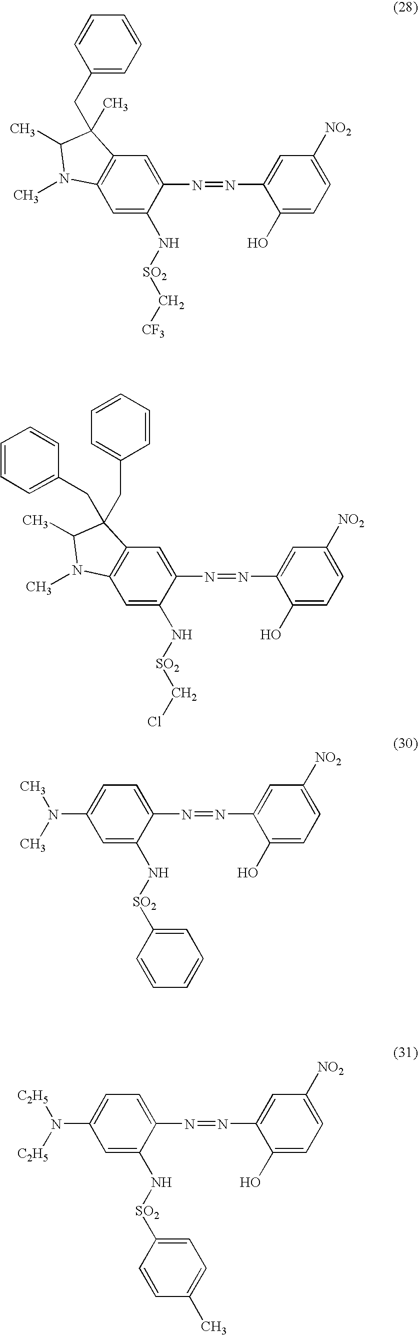

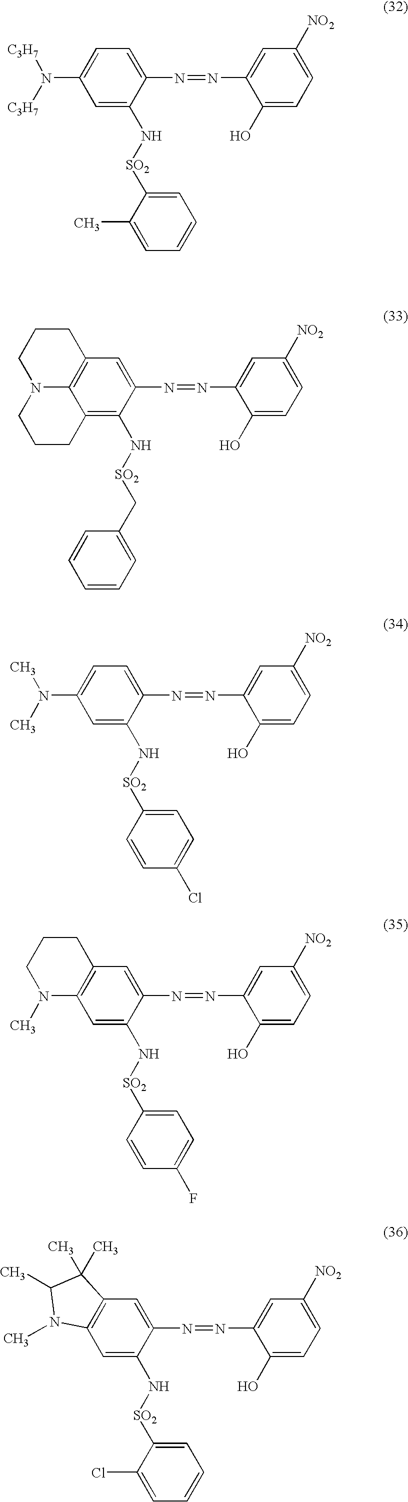

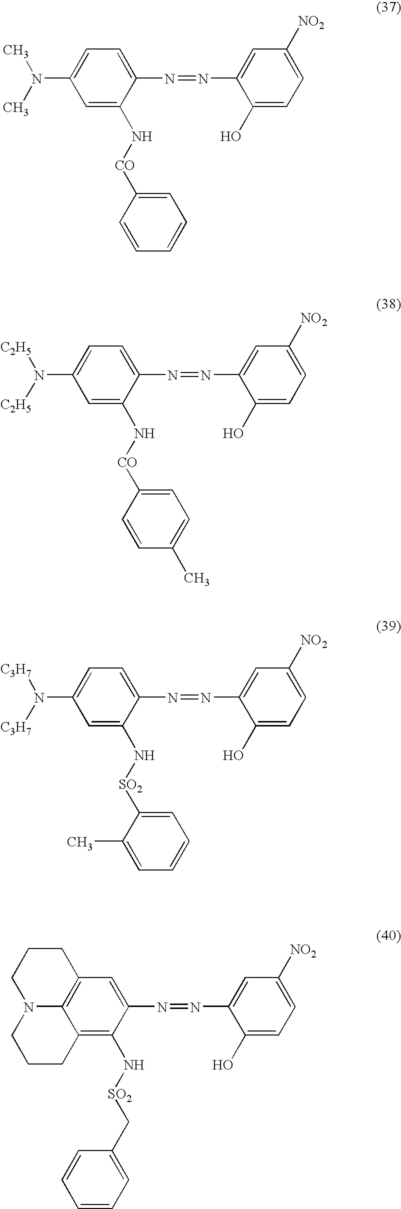

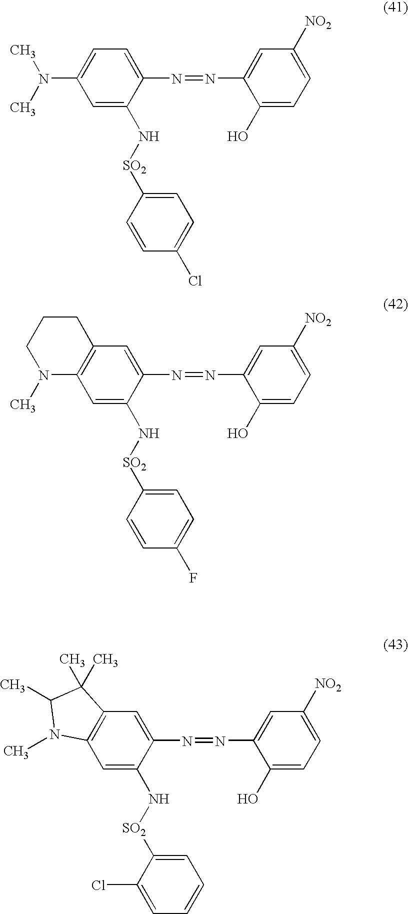

As metals (central metals) for chelate compounds there may be mentioned titanium, vanadium, chromium, manganese, iron, cobalt, nickel, copper, zirconium, niobium, molybdenum, ruthenium, rhodium, palladium, silver, cadmium, indium, tin, antimony, tungsten, rhenium, osmium, iridium, platinum and gold, among which cobalt and nickel are preferred.

For chelate compounds preferably used according to the invention, a coordination bond is formed between the metal and the tridentate ligand resulting from dissociation of two active hydrogen atoms from an azo compound represented by any of general formulas (6) to (8). For example, a chelate compound formed by an azo compound represented by general formula (7) or (8) and cobalt (Co) as the metal has two tridentate ligands coordinated with a single cobalt atom, as shown in general formulas (44) and (45) below.

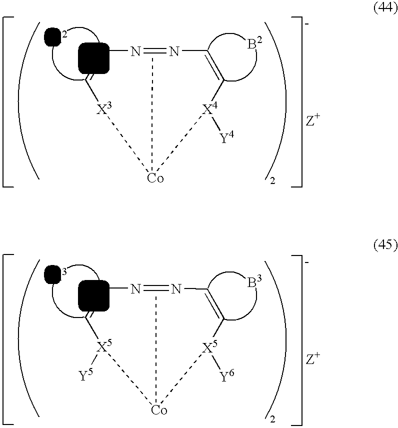

According to the invention, using an organic dye having the structure described above allows adequate inhibition of both gas generation due to thermal decomposition and the accompanying atmosphere pressure fluctuation. In addition, the sensitivity and high-speed responsiveness can be improved, and the light resistance can be enhanced while maintaining a high level of precise recording pit formation even under high temperature conditions. Consequently, the organic dye is extremely useful as an organic dye for high-speed, high-reliability optical recording media suitable for recording and reading light of short wavelengths. Incidentally, the refractive index of the organic dye is not particularly restricted but preferably the real part of the complex refractive index n is 1.8-2.7 and the imaginary part k is 0.01-0.1 for the laser wavelength. The melting point of the organic dye is preferably 180° C.

(Optical Recording Medium)

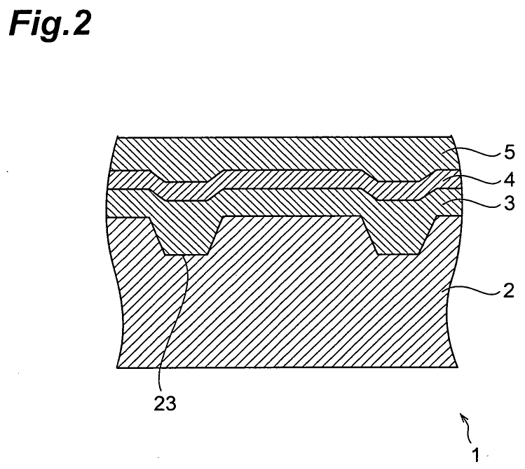

FIG. 2 is a partial cross-sectional view showing a preferred embodiment of an optical recording disk as an optical recording medium according to the invention. The optical recording disk 1 shown in FIG. 2 is a write-once optical recording compact disk conforming to the CD standard.

The optical recording disk 1 has a laminated structure comprising a recording layer 3, reflective layer 4 and protective sheet bonded in that order on a substrate 2.

The substrate 2 is disk-shaped, with a diameter of about 64-200 mm and a thickness of about 1.2 mm The substrate 2 preferably has essential transparency for the recording light and reading light in order to allow recording and reading from the back side (opposite side from the recording layer 3), and more specifically, the substrate 2 preferably has a transmittance of 88% or greater for the recording and reading light. As materials for the substrate 2 there are preferred resin or glass materials satisfying the transmittance conditions mentioned above, and particularly preferred are thermoplastic resins such as polycarbonate resins, acrylic resins, amorphous polyethylene, TPX and polystyrene resins.

A tracking groove 23 is formed on the recording layer 3-formed side of the substrate 2, as shown in FIG. 2. The groove 23 is preferably a continuous spiral groove, with a depth of 0.1-0.25 μm, a width of 0.35-0.60 μm and a groove pitch determined according to the standard for each disk. By forming the groove in this manner it will be possible to obtain a satisfactory tracking signal without lowering the reflection level of the groove. The groove 23 may be formed simultaneously with molding of the substrate 2 by extrusion molding using the aforementioned resin, but alternatively a resin layer having a groove 23 may be formed by the 2P method after manufacture of the substrate 2, and a composite substrate formed from the substrate 2 and the resin layer.

The recording layer 3 is formed using an organic dye according to the invention, i.e. an organic dye comprising an organic dye matrix, and at least one C7 or greater branched organic group bonded by a single bond to the organic dye matrix and branching at a prescribed position into a C5 or greater organic group and a functional group other than a hydrogen atom, and/or at least two C5 or greater organic groups other than the branched organic group(s).

The recording layer 3 may be formed by coating the substrate 2 with a coating solution comprising an organic dye according to the invention, and drying the coating if necessary. Since the organic dye of the invention exhibits satisfactory solubility for polar solvents, the solvent used for the coating solution may be alcohol-based, cellosolve-based, alkoxyalcohol-based, ketoalcohol-based (diacetone alcohol, etc.), ketone-based (cyclohexanone, etc.), or a fluorinated alcohol (2,2,3,3-tetrafluoropropanol, etc.). These solvents may be used alone or as mixtures of two or more. When the substrate 2 is made of carbonate, it is preferred to use ethylcellosolve or 2,2,3,3-tetrafluoropropanol which will not corrode the substrate. Appropriate amounts of binders, dispersing agents, stabilizers and the like may also be included. The content of the organic pigment in the coating solution is preferably 0.05-10 wt %.

The method of applying the coating solution may be spin coating, gravure coating, spray coating or dip coating, among which spin coating is preferred. The temperature for drying of the formed coating is preferably 40-100° C. During preparation of the coating solution, it is preferred to select beforehand an organic dye in which the C5 or greater organic group dissociates at a temperature lower than the kick-off temperature of the organic dye matrix.

The thickness of the recording layer 3 formed in this manner is preferably 50-300 nm as the dry film thickness. A thickness outside of this range will lower the reflectance and render it difficult to achieve reading in a manner conforming to the CD standard.

The extinction coefficient (imaginary part of the complex refractive index k) of the recording layer 3 for the recording light and reading light is preferably 0.01-0.10. If the extinction coefficient is greater than 0.10, sufficient reflectance may not be achieved. The refractive index (real part of the complex refractive index n) of the recording layer 3 is preferably at least 1.8. If the refractive index is less than 1.8, the modulation factor of the signal will tend to be smaller. The upper limit for the refractive index is not particularly restricted, but it will normally be about 2.7 for convenience of the organic dye synthesis.

The extinction coefficient and refractive index of the recording layer 3 may be determined according to the following procedure. First, a measurement sample is fabricated by forming a recording layer of about 40-100 nm on a prescribed transparent substrate, and then the reflectance through the measurement sample substrate or the reflectance from the recording layer side is measured. In this case, the reflectance is measured based on mirror reflection (about 5°) using the wavelength of the recording and reading light. The light transmittance of the sample is also measured. The measured values may be used to calculate the extinction coefficient and refractive index according to the method described in, for example, “Kogaku [Optics]”, K. Ishiguro, pp. 168-178, Kyoritsu Zensho Publishing.

A reflective layer 4 is provided on the recording layer 3 by bonding onto the recording layer 3. The reflective layer 4 may be formed by vapor deposition, sputtering or the like using a metal or alloy with high reflectance. As metals and alloys there may be mentioned gold (Au), copper (Cu), aluminum (Al), silver (Ag), AgCu and the like. The thickness of the reflective layer 4 formed in this manner is preferably 50-120 nm.

On the reflective layer 4 there is formed a protective layer 5 by bonding onto the reflective layer 4. The protective layer 5 may be in layer or sheet form, and for example, it may be formed by coating the reflective layer 4 with a coating solution containing a material such as an ultraviolet curing resin and drying the coated solution if necessary. The coating may be accomplished by appropriate spin coating, gravure coating, spray coating, dip coating or the like. The thickness of the protective layer 5 formed in this manner is preferably 0.5-100 μm.

For recording or write-once recording of the optical recording disk having such a construction, the recording light of a prescribed wavelength is irradiated from the back side of the substrate 2 in a pulse manner and the light reflectance of the irradiated portion is varied. The recording layer absorbs light and generates heat during this time, but the use of the aforementioned specific organic dye according to this embodiment adequately prevents generation of gas by thermal decomposition of the organic dye and the accompanying pressure fluctuation. Consequently, it is possible to form precise recording pits even under high-temperature conditions, while also achieving a high level of sensitivity and high-speed responsiveness.

This embodiment was explained as an optical recording disk provided with a single recording layer 3, but a plurality of recording layers may instead be provided, with a different organic dye in each layer. This will allow recording and reading of information to be accomplished by a plurality of recording/reading beams of different wavelengths.

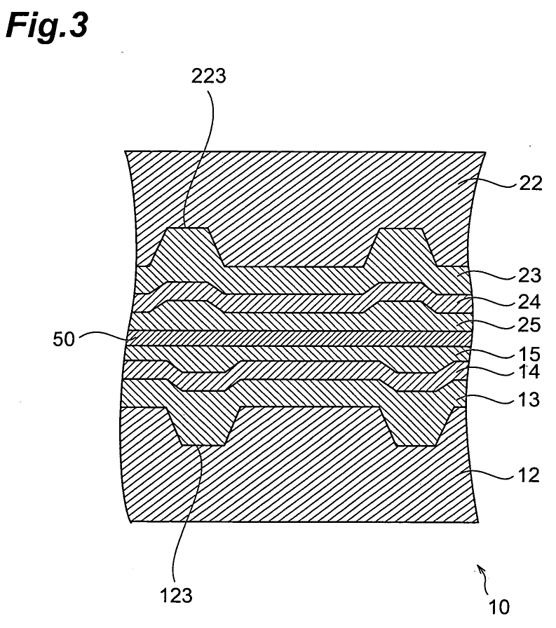

FIG. 3 is a partial cross-sectional view showing a preferred embodiment of an optical recording disk as an optical recording medium according to the invention. The optical recording disk 10 shown in FIG. 3 is a write-once digital video disk conforming to the DVD standard, whereby recording and reading are accomplished by light with a short wavelength of 635-660 nm.

The optical recording disk 10 has a construction wherein two optical recording disks having the same construction as the optical recording disk 1 shown in FIG. 2 are attached together with their respective protective layers facing and sandwiching an adhesive layer. Specifically, the optical recording disk 10, as seen from the side, has a laminated structure comprising a substrate 12, a recording layer 13, a reflective layer 14, a protective layer 15, an adhesive layer 50, a protective layer 25, a reflective layer 24, a recording layer 23 and a substrate 22 formed in that order.

The material used for the adhesive layer 50 is preferably a thermosetting resin or the like, and the thickness of the adhesive layer 50 is preferably about 10-200 μm.

The constructions of the substrates 12 and 22, the recording layers 13 and 23, the reflective layers 14 and 24 and the protective layers 15 and 25 are the same as for the optical recording disk 1 shown in FIG. 2. The thicknesses of the substrates 12 and 22 are about 0.6 mm each. Grooves 123 and 223 are formed on the side of the substrate 12 on which the recording layer 13 is formed and on the side of the substrate 23 on which the recording layer 24 is formed, respectively, and the grooves 123 and 223 have depths of 60-200 nm, widths of 0.2-0.5 μm and groove pitches of 0.6-1.0 μm. The thicknesses of the recording layers 13 and 23 are 50-300 nm, and the complex refractive index for light of 650 nm is n=1.8-2.7, k=0.01-0.10.

### EXAMPLES

The present invention will now be explained in greater detail through examples and comparative examples, with the understanding that the examples are in no way limitative on the invention.

### Example 1

First, a polycarbonate resin substrate with a 120 mm diameter and a 0.6 mm thickness was prepared, having a pre-groove (0.18 μm depth, 0.35 μm width, 0.74 μm groove pitch) formed on one side. Separately, the organic dye represented by formula (46) below was added to 2,2,3,3-tetrafluoropropanol to a content of 1.0 wt % to prepare a recording layer coating solution. The obtained coating solution was applied onto the side of the aforementioned polycarbonate resin substrate on which the pre-groove had been formed, and dried to form a recording layer (130 nm thickness). Next, an Ag reflective film (85 nm thickness) was formed on the recording layer by sputtering, and a transparent protective layer (5 μm thickness) composed of an ultraviolet curing acryl resin was formed on the Ag reflective layer to obtain a laminated structure. Two such laminated structures were fabricated and attached by an adhesive with their protective layers facing inward, to obtain an optical recording disk having the structure shown in FIG. 3.

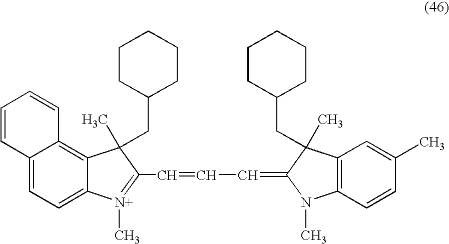

### Example 2

An optical recording disk was fabricated in the same manner as Example 1, except that the organic dye represented by formula (47) below was used instead of the organic dye represented by formula (46).

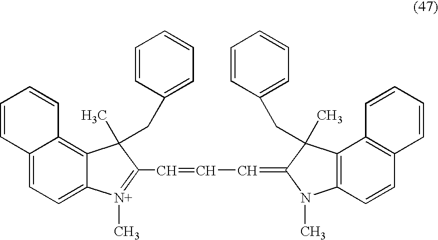

### Example 3

An optical recording disk was fabricated in the same manner as Example 1, except that the organic dye represented by formula (48) below was used instead of the organic dye represented by formula (46).

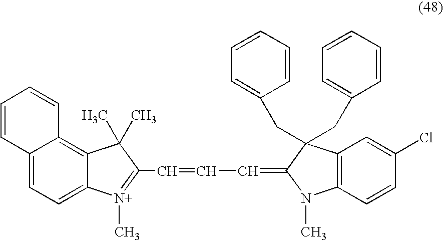

### Example 4

An optical recording disk was fabricated in the same manner as Example 1, except that the organic dye represented by formula (49) below was used instead of the organic dye represented by formula (46).

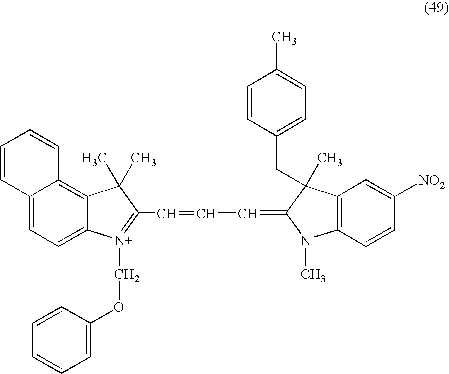

### Example 5

An optical recording disk was fabricated in the same manner as Example 1, except that the organic dye represented by formula (50) below was used instead of the organic dye represented by formula (46).

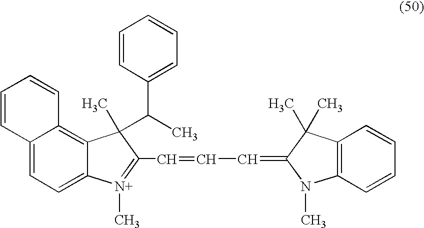

### Example 6

An optical recording disk was fabricated in the same manner as Example 1, except that the organic dye represented by formula (51) below was used instead of the organic dye represented by formula (46).

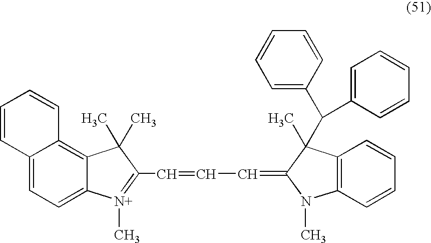

### Example 7

An optical recording disk was fabricated in the same manner as Example 1, except that the organic dye represented by formula (52) below was used instead of the organic dye represented by formula (46).

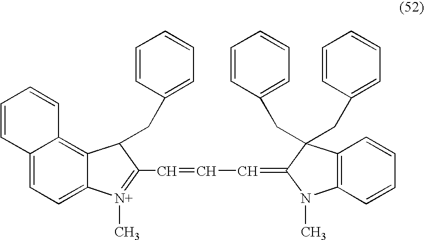

### Example 8

An optical recording disk was fabricated in the same manner as Example 1, except that the organic dye represented by formula (47) was used with a chelate compound of an azo compound and cobalt as represented in formula (20), instead of the organic dye represented by formula (46).

### Comparative Example 1

An optical recording disk was fabricated in the same manner as Example 1, except that the organic dye represented by formula (53) below was used instead of the organic dye represented by formula (46).

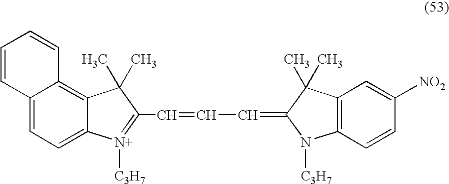

### Comparative Example 2

An optical recording disk was fabricated in the same manner as Example 1, except that the organic dye represented by formula (54) below was used instead of the organic dye represented by formula (46).

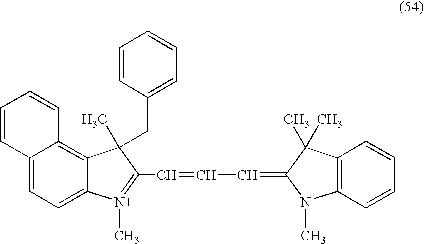

Next, information was recorded by laser light with a wavelength of 660 nm using the optical disks of Examples 1-4 and Comparative Example 1, and the reading characteristic was evaluated. Two conditions were used for this test, a recording speed of either 1× or 8×. The optimum recording power, reflectance and jitter were used as indices for evaluation of each optical recording disk. The results are shown in Table 1.

TABLE 1

| | 1× speed | | | 8× speed | | |
|---|---|---|---|---|---|---|
| | Power | Reflectance | Jitter | Power | Reflectance | Jitter |
| | (mW) | (%) | (%) | (mW) | (%) | (%) |
| Example 1 | 7.2 | 49 | 7.2 | 27.0 | 49 | 7.9 |
| Example 2 | 6.5 | 45 | 7.0 | 25.5 | 43 | 6.7 |
| Example 3 | 7.1 | 50 | 7.2 | 26.8 | 50 | 6.7 |
| Example 4 | 7.3 | 49 | 7.2 | 27.2 | 48 | 7.8 |
| Example 5 | 6.5 | 46 | 7.2 | 26.9 | 46 | 7.0 |
| Example 6 | 6.9 | 49 | 7.2 | 26.8 | 50 | 6.8 |
| Example 7 | 6.8 | 47 | 7.1 | 27.0 | 50 | 6.9 |
| Example 8 | 6.5 | 46 | 7.8 | 25.5 | 46 | 7.0 |
| Comp. | 7.3 | 49 | 8.1 | 27.5 | 48 | 14 |
| Ex. 1 | | | | | | |
| Comp. | 8.0 | 52 | 7.9 | 29.9 | 52 | 8.5 |
| Ex. 2 | | | | | | |

As shown in Table 1, the optical recording disks of Examples 1-7 all exhibited excellent sensitivity and high-speed responsiveness, and in particular, a jitter of 8% or less was confirmed.

As explained above, according to the present invention there is provided an optical recording medium which allows formation of precise recording pits under high-temperature conditions and exhibits excellent sensitivity and high-speed responsiveness, as well as a manufacturing method which allows the optical recording medium to be obtained in an easy and reliable manner. In particular, it is possible to realize an optical recording medium which is superior to conventional optical recording media under increasing recording speeds.

1. An optical recording material used for an optical recording medium capable of recording information by irradiation of light,
the optical recording material comprising an organic dye having an organic dye matrix, and at least one C7 or greater branched organic group bonded by a single bond to said organic dye matrix and branching at a prescribed position into a C5 or greater organic group and a functional group other than a hydrogen atom, and/or at least two C5 or greater organic groups other than said branched organic group.

2. An optical recording material according to claim 1, said organic dye being one wherein said C5 or greater organic group dissociates at a lower temperature than the kick-off temperature of said organic dye matrix.

3. An optical recording material according to claim 1, wherein said organic dye has a structure represented by any of the following general formulas (1) to (4). 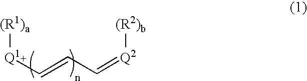
wherein Q¹ and Q² may be the same or different and each represents a nitrogen-containing heterocycle optionally including a fused ring, n represents an integer of 0-3, R¹ and R² may be the same or different and each represents a C7 or greater branched organic group branching at a prescribed position into a C5 or greater organic group and a functional group other than a hydrogen atom, or a C5 or greater organic group other than said branched organic group, and a and b may be the same or different and each represents an integer, provided that when the a number of R¹ groups and b number of R² groups include said branched organic group, the sum of a and b is 1 or greater, and when the a number of R¹ groups and b number of R² groups do not include said branched organic group, the sum of a and b is 2 or greater. 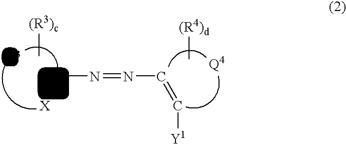
wherein Q³ and Q⁴ may be the same or different and each represents a group of atoms forming an aromatic ring, X represents a carbon atom, nitrogen atom, oxygen atom or sulfur atom, Y¹ represents hydroxyl, carboxyl or sulfone, R³ and R⁴ may be the same or different and each represents a C7 or greater branched organic group branching at a prescribed position into a C5 or greater organic group and a functional group other than a hydrogen atom, or a C5 or greater organic group other than said branched organic group, and c and d may be the same or different and each represents an integer, provided that when the c number of R³ groups and d number of R⁴ groups include said branched organic group, the sum of c and d is 1 or greater, and when the c number of R³ groups and d number of R⁴ groups do not include said branched organic group, the sum of c and d is 2 or greater. 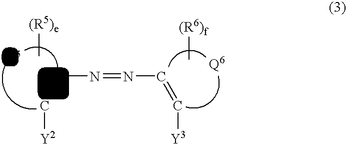
wherein Q⁵ and Q⁶ may be the same or different and each represents a group of atoms forming an aromatic ring, Y²and Y³ may be the same or different and each represents hydroxyl, carboxyl or sulfone, R⁵ and R⁶ may be the same or different and each represents a C7 or greater branched organic group branching at a prescribed position into a C5 or greater organic group and a functional group other than a hydrogen atom, or a C5 or greater organic group other than said branched organic group, and e and f may be the same or different and each represents an integer, provided that when the e number of R⁵ groups and f number of R⁶ groups include said branched organic group, the sum of e and f is 1 or greater, and when the e number of R⁵ groups and f number of R⁶ groups do not include said branched organic group, the sum of e and f is 2 or greater. 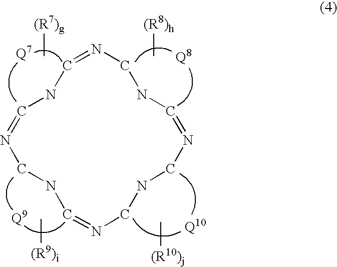
wherein Q⁷, Q⁸, Q⁹ and Q¹⁰ may be the same or different and each represents a group of atoms forming an aromatic ring, R⁷, R⁸, R⁹ and R¹⁰ may be the same or different and each represents a C7 or greater branched organic group branching at a prescribed position into a C5 or greater organic group and a functional group other than a hydrogen atom, or a C5 or greater organic group other than said branched organic group, and g, h, i and j may be the same or different and each represents an integer, provided that when the g number of R⁷ groups, h number of R⁸ groups, i number of R⁹ groups and j number of R¹⁰ groups include said branched organic group, the sum of g, h, i and j is 1 or greater, and when the g number of R⁷ groups, h number of R⁸ groups, i number of R⁹ groups and j number of R¹⁰ groups do not include said branched organic group, the sum of g, h, i and j is 2 or greater.

4. An optical recording material according to claim 1, wherein said C5 or greater organic group is one selected from among aryl, arylalkyl, alkylaryl, cycloalkyl, alkylcycloalkyl, cycloalkylalkyl and adamantane residues having one hydrogen atom removed.

5. An optical recording material according to claim 1, wherein said organic dye has a structure represented by general formula (1) below, and said optical recording material further comprises a chelate compound of an azo compound and a metal. 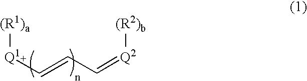
wherein Q¹ and Q² may be the same or different and each represents a nitrogen-containing heterocycle optionally including a fused ring, n represents an integer of 0-3, R¹ and R² may be the same or different and each represents a C7 or greater branched organic group branching at a prescribed position into a C5 or greater organic group and a functional group other than a hydrogen atom, or a C5 or greater organic group other than said branched organic group, and a and b may be the same or different and each represents an integer, provided that when the a number of R¹ groups and b number of R² groups include said branched organic group, the sum of a and b is 1 or greater, and when the a number of R¹ groups and b number of R² groups do not include said branched organic group, the sum of a and b is 2 or greater.

6. An optical recording medium capable of recording information by irradiation of light,
the optical recording medium being provided with a recording layer comprising an organic dye having an organic dye matrix, and at least one C7 or greater branched organic group bonded by a single bond to said organic dye matrix and branching at a prescribed position into a C5 or greater organic group and a functional group other than a hydrogen atom, and/or at least two C5 or greater organic groups other than said branched organic group.

7. An optical recording medium according to claim 6, said organic dye being one wherein said C5 or greater organic group dissociates at a lower temperature than the kick-off temperature of said organic dye matrix.

8. An optical recording medium according to claim 6, wherein said organic dye has a structure represented by any of the following general formulas (1) to (4). 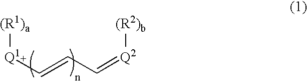
wherein Q¹ and Q² may be the same or different and each represents a nitrogen-containing heterocycle optionally including a fused ring, n represents an integer of 0-3, R¹ and R² may be the same or different and each represents a C7 or greater branched organic group branching at a prescribed position into a C5 or greater organic group and a functional group other than a hydrogen atom, or a C5 or greater organic group other than said branched organic group, and a and b may be the same or different and each represents an integer, provided that when the a number of R¹ groups and b number of R² groups include said branched organic group, the sum of a and b is 1 or greater, and when the a number of R¹ groups and b number of R² groups do not include said branched organic group, the sum of a and b is 2 or greater. 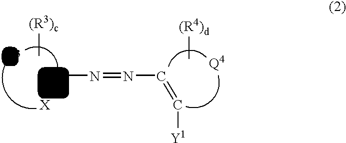
wherein Q³ and Q⁴ may be the same or different and each represents a group of atoms forming an aromatic ring, X represents a carbon atom, nitrogen atom, oxygen atom or sulfur atom, Y¹ represents hydroxyl, carboxyl or sulfone, R³ and R⁴ may be the same or different and each represents a C7 or greater branched organic group branching at a prescribed position into a C5 or greater organic group and a functional group other than a hydrogen atom, or a C5 or greater organic group other than said branched organic group, and c and d may be the same or different and each represents an integer, provided that when the c number of R³ groups and d number of R⁴ groups include said branched organic group, the sum of c and d is 1 or greater, and when the c number of R³ groups and d number of R⁴ groups do not include said branched organic group, the sum of c and d is 2 or greater. 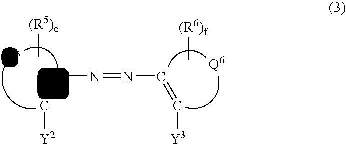
wherein Q⁵ and Q⁶ may be the same or different and each represents a group of atoms forming an aromatic ring, Y² and Y³ may be the same or different and each represents hydroxyl, carboxyl or sulfone, R⁵ and R⁶ may be the same or different and each represents a C7 or greater branched organic group branching at a prescribed position into a C5 or greater organic group and a functional group other than a hydrogen atom, or a C5 or greater organic group other than said branched organic group, and e and f may be the same or different and each represents an integer, provided that when the e number of R⁵ groups and f number of R⁶ groups include said branched organic group, the sum of e and f is 1 or greater, and when the e number of R⁵ groups and f number of R⁶ groups do not include said branched organic group, the sum of e and f is 2 or greater. 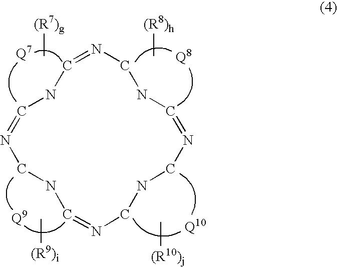
wherein Q⁷, Q⁸, Q⁹ and Q¹⁰ may be the same or different and each represents a group of atoms forming an aromatic ring, R⁷, R⁸, R⁹ and R¹⁰ may be the same or different and each represents a C7 or greater branched organic group branching at a prescribed position into a C5 or greater organic group and a functional group other than a hydrogen atom, or a C5 or greater organic group other than said branched organic group, and g, h, i and j may be the same or different and each represents an integer, provided that when the g number of R⁷ groups, h number of R⁸ groups, i number of R⁹ groups and j number of R¹⁰ groups include said branched organic group, the sum of g, h, i and j is 1 or greater, and when the g number of R⁷ groups, h number of R⁸ groups, i number of R⁹ groups and j number of R¹⁰ groups do not include said branched organic group, the sum of g, h, i and j is 2 or greater.

9. An optical recording medium according to claim 6, wherein said C5 or greater organic group is one selected from among aryl, arylalkyl, alkylaryl, cycloalkyl, alkylcycloalkyl, cycloalkylalkyl and adamantane residues having one hydrogen atom removed.

10. An optical recording medium according to claim 6, wherein said organic dye has a structure represented by general formula (1) below, and said recording layer further comprises a chelate compound of an azo compound and a metal. 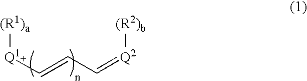
wherein Q¹ and Q² may be the same or different and each represents a nitrogen-containing heterocycle optionally including a fused ring, n represents an integer of 0-3, R¹ and R² may be the same or different and each represents a C7 or greater branched organic group branching at a prescribed position into a C5 or greater organic group and a functional group other than a hydrogen atom, or a C5 or greater organic group other than said branched organic group, and a and b may be the same or different and each represents an integer, provided that when the a number of R¹ groups and b number of R² groups include said branched organic group, the sum of a and b is 1 or greater, and when the a number of R¹ groups and b number of R² groups do not include said branched organic group, the sum of a and b is 2 or greater.

11. A method for manufacturing an optical recording medium, the method comprising:
a first step of preparing an organic dye having an organic dye matrix, and at least one C7 or greater branched organic group bonded by a single bond to said organic dye matrix and branching at a prescribed position into a C5 or greater organic group and a functional group other than a hydrogen atom, and/or at least two C5 or greater organic groups other than said branched organic group(s),
a second step of preparing a coating solution comprising said organic dye, and
a third step of applying said coating solution onto a substrate to form a recording layer.

12. A method for manufacturing an optical recording medium according to claim 11, wherein for said first step, there is selected an organic dye having C5 or greater organic group which dissociates at a lower temperature than the kick-off temperature of said organic dye matrix.
